(19) United States
(12) Patent Application Publication
(10) Pub. No.: US 2003/0046146 A1
(43) Pub. Date: Mar. 6, 2003

(54) Method and system for providing an automobile concierge service to a client as an incentive for the client to enter into a business relationship

(76) Inventors: David Westerman, Beverly Hills, MI (US); James Distler, West Bloomfield, MI (US)

Correspondence Address: BROOKS & KUSHMAN P.C./FGTI, 1000 TOWN CENTER, 22ND FLOOR, SOUTHFIELD, MI, 48075, US

(21) Appl. No.: 09/682,442

(22) Filed: Sep. 4, 2001

(51) Int. Cl. G06F 17/60

(52) U.S. Cl. 705/14

(57) ABSTRACT

A method and computer-based system for providing an automobile concierge service to a client as an incentive for the client to enter into a business relationship such as an employment agreement, a landlord-tenant arrangement and a term-parking agreement include receiving a client's request for an automobile service, coordinating with an automobile service provider to schedule the requested service, transporting the client's vehicle to the service provider to perform the at least one scheduled automobile service, and returning the vehicle to the client after the service is complete. The method additionally includes receiving a client's request to acquire an automobile and locating an automobile acquisition opportunity that best satisfies the client's request.

### BACKGROUND OF INVENTION

This invention relates generally to commercial marketing and, more particularly, to a method and system for providing an automobile concierge service to a client as an incentive for the client to enter into a business relationship.

In many sectors of the workforce today, employers are placing higher demands on their employees. Despite the advent of time-saving computer technology and flexible work environments, employees are constantly struggling to meet their employer demands to increase output and value-added work product.

As a result of the ever-increasing performance benchmark many of today's employees are faced with, the employees incessantly strive to become more efficient in their daily lives by minimizing the time they invest performing menial chores, or hiring others to perform them. Doing so provides employees with an opportunity to meet the increasing demands of their employer without sacrificing time for the more important things in life: family, friends and personal time.

Contemporaneous with this employee struggle, employers are constantly struggling to maintain or create a loyal, versatile and competent employee base. Today, employees need only login to any one of the online career-searching tools or bulletin boards to browse a myriad of competitive career options. In addition, employees are more transient than in the past, often willing to relocate as often as the next-better employment opportunity presents itself. Essentially, the proverbial “tables have turned” on the traditional recruiting process. Instead of a company interviewing several employee candidates to flush out the most qualified person for the job, the candidates are often interviewing several companies for the company that best suits the candidate personal preference. Because of the highly-competitive marketplace and the level at which employee candidates are informed, employers are forced to truly innovate and advertise creative marketing strategies and incentives that tend to make their company more attractive to the employee candidate than another.

Similar to employers, many commercial industries are also struggling to implement innovative and creative marketing plans and incentives intended to draw clients away from competitors and into their storefront. Unfortunately, clients are inundated and often overwhelmed with massive marketing campaigns full of fancy colors and fine print which often reveals that what promoters are actually offering is not nearly what the clients initially expected.

What is needed is an innovative method for relieving employees and other business clients of time-consuming burdens associated with the ownership and maintenance of their automobile, while at the same time providing employers and other participants in today's commercial marketplace with a bonafide incentive to offer clients in exchange for their business.

### SUMMARY OF INVENTION

One embodiment of the present invention comprises a method for providing an automobile concierge service to a client as an incentive for the client to enter into a business relationship such as an employment agreement, a landlord-tenant arrangement and a term-parking agreement. The method includes receiving a client's request for an automobile service, coordinating with an automobile service provider to schedule the requested service, transporting the client's vehicle to the service provider to perform the scheduled automobile service, and returning the vehicle to the client after the service is complete.

Additionally, the method includes receiving a client's request to acquire an automobile and locating an automobile acquisition opportunity that best satisfies the client's request.

Another embodiment of the present invention comprises a computer-based system for supporting the provision of an automobile concierge service to a client as an incentive for the client to enter into a business relationship. The system is configured to receive input containing a client's request for an automobile service, present output containing an automobile service provider capable of providing the automobile service, and receive input scheduling the automobile service.

### BRIEF DESCRIPTION OF DRAWINGS

FIG. 1 is a block flow diagram illustrating an overview of a method for providing clients with a concierge service for servicing vehicles in accord with a preferred embodiment of the present invention;

FIG. 2 is a block flow diagram illustrating an overview of a method for providing clients with a concierge service for purchasing and leasing vehicles in accord with a preferred embodiment of the present invention; and

FIG. 3 illustrates a preferred system for managing data associated with the provision of concierge services in accord with a preferred embodiment of the present invention.

### DETAILED DESCRIPTION

One aspect of the present invention comprises a method for providing clients with a concierge service for servicing vehicles. In accord with this aspect of the invention, a client need only communicate with a concierge service call center or account manager to assure proper and complete service to the client's vehicle. In other words, the client is relieved of the often painstaking tasks of locating, negotiating and otherwise personally dealing with vehicle service centers and service center personnel.

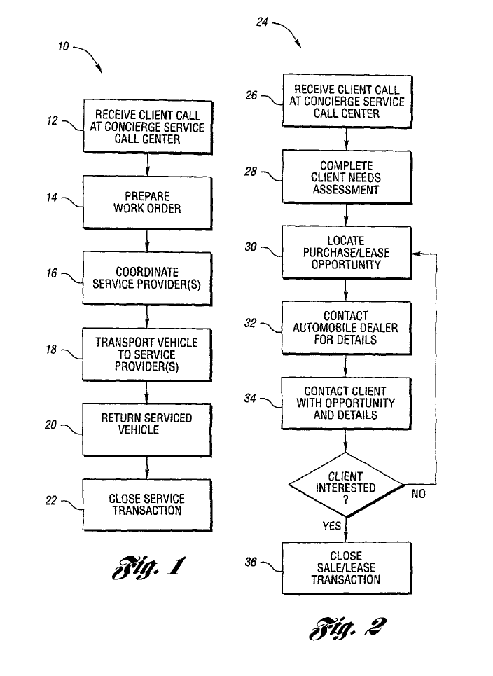

FIG. 1 is a block flow diagram illustrating an overview of a method for providing clients with a concierge service for servicing vehicles in accord with a preferred embodiment of the present invention. The preferred method 10 comprises receiving a client's service request at a concierge call center or from an account manager 12, preparing a work order based on the client's service request 14, coordinating an appropriate service provider 16, transporting the vehicle from the client's location to the service provider 18, returning the serviced vehicle to the client 20 and closing the concierge service transaction 22.

Receiving a client's service request at a concierge call center or from an account manager comprises receiving and listening to the client's service request to identify the client's particular needs. Service requests may include but are not limited to any of the following: routine maintenance and non-routine repairs, insurance estimates and collision/dent repairs, car washes and detailing, oil changes, warranty repairs, recall repairs, windshield repairs, smog/emission checks, purchase and installation of automotive accessories, and temporary transportation assistance (i.e., arrange rental car, limousine, shuttles, short term lease).

Preferably, the account manager receiving the service request asks relevant questions and restates the client's needs back to the client for confirmation and overall service request accuracy. It is additionally preferred that an account manager responding to a client's service request possesses effective communication skills and has a comprehensive knowledge of basic automotive terms, available service offerings and price schedules. Marketing resources that may be helpful to an account manager responding to a client's service request include but are not limited to a consumer brochure, a listing of prepaid clients, a current price schedule, an executive brochure, a listing of all available services, and a listing of available bundled services and corresponding pricing, dealer operations and how to effectively access and search the database of preselected service providers.

Once the account manager has assessed the client's service request, the account manager accesses an online customer relationship management system, discussed in more detail, infra, and prepares a work order for the concierge services to be rendered. The work order comprises client information, vehicle information, required services, payment method, other special details, disclaimer of warranties, insurance/bailment representations, authorization and a vehicle inspection section to note the vehicle's condition (e.g., exterior/interior condition).

To coordinate the appropriate service provider(s) for completing the work order, the account manager responding to the client's service request accesses a service provider database aspect of the online customer relationship management system. The service provider database comprises a listing of preselected service providers, each listing including the name and location of the service provider and the services rendered. Preferably, the service providers included within the database are selected based on a demonstrated history of reliable and quality workmanship. Once the most appropriate service provider(s) is/are identified, the account manager contacts the service provider(s) to communicate the appropriate work order/entries, set up an appointment, obtain a repair timing and cost estimates and check loaner vehicle availability where necessary.

Transporting the client's vehicle from the client's location to the service provider(s) begins with the account manager contacting the client to set up a time and location for vehicle pickup. Upon meeting the client for vehicle pick-up, the account manager reviews and confirms the work order with the client, inspects the vehicle in its pre-pickup condition and up-sells the client on additional concierge services.

Next, the account manager communicates with the selected service provider(s) to arrange transport of the vehicle to and from the service provider and to confirm the appropriate work order items and estimated completion time. Preferably, the account manager then contacts the client to inform him or her of the estimated completion time. It is additionally preferred that the account manager contact the service provider periodically to confirm the prompt maintenance of repair of the client's automobile. Notably, the account manager contacts the client with any significant problems associated with the maintenance or repair.

Closing the concierge service transaction begins with taking re-delivery of the vehicle from the service provider. Upon re-delivery from the service provider, the account manager evaluates the services rendered and obtains an explanation of the work done on the vehicle and charges. Upon satisfaction that the work order has been properly completed, the account manager completes payment with the service provider and returns the vehicle to the client.

Preferably, the account manager places a concierge service reminder sticker in the upper-lefthand corner of the vehicle windshield before returning the vehicle to the client. Upon meeting with the client, the account manager confirms the work performed on the vehicle, assesses the client's satisfaction, arranges for payment of services rendered and discusses the scheduling of future concierge services.

Upon return to the concierge office, the account manager processes payment for the services rendered. In addition, the account manager accesses a future service scheduling aspect of the online customer relationship management system and schedules any future concierge services that the client desired. The account manager also accesses a client information aspect of the online customer relationship management system to add or update the client's record. Client records comprise information including but not limited to the client's name, address and contact information, payment information, historical service information, vehicle information and account status including a prepaid status if applicable.

Preferably, the scheduling aspect of the online customer relationship management system automatically prompts an account manager to contact a client (via mail, telephone, e-mail, etc.) regarding any previously-scheduled future concierge services.

An alternate embodiment of the method for providing the automobile concierge services includes an online client self-service interface. The client self-service interface provides a client with the ability to interactively request and schedule concierge services discussed, supra. Instead of telephoning a concierge call center or an account manager to arrange concierge services, the client can access the interactive online client self-service interface. This alternate feature allows the client the flexibility commonly associated with online browsing and transactions including but not limited to 24-hour availability, remote access and pleasure of browsing available services, bundles and options at a comfortable pace.

Another aspect of the present invention comprises a method for providing clients with a concierge service for buying and leasing vehicles. In accord with this aspect of the invention, a client need only communicate with a concierge service call center or an account manager to purchase or lease a vehicle. In other words, the client is relieved of the tasks of locating, negotiating and otherwise personally dealing with automobile dealerships.

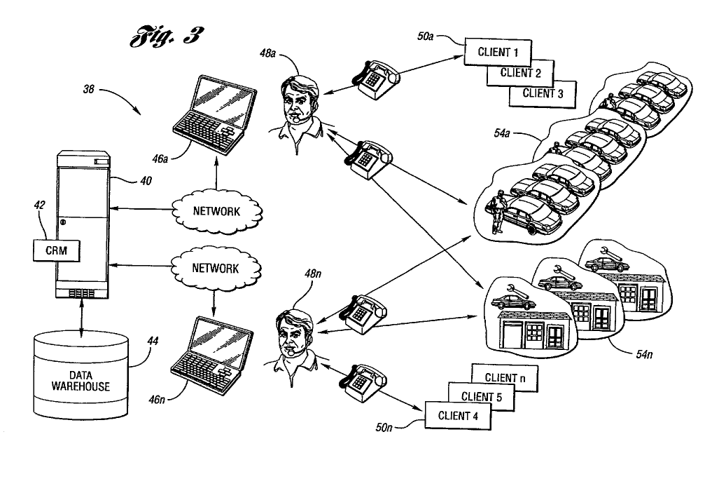

FIG. 2 is a block flow diagram illustrating an overview of a method for providing clients with a concierge service for purchasing and leasing vehicles in accord with the present invention. The method 24 comprises receiving a client's call at a concierge call center or from an account manager 26, completing a client needs assessment 28, locating a purchase or lease opportunity that best matches the client's particular needs 30, contacting an appropriate franchised automobile dealer for details of purchase or lease 32, communicating the opportunity and details to the client 34 and closing the purchase or lease transaction according to state laws 36.

Receiving a client's call at a concierge call center or from an account manager comprises assessing the clients particular needs to determine an appropriate product or service. Preferably, the account manager completes a needs assessment for each client. The needs assessment comprises vehicle type desired (e.g., car, truck, SUV, minivan) application, use, price range/financing, timing, miles driven/year and availability.

Additionally, the account manager may explain key differences between leasing and purchasing to the client so the client can thereafter make an educated decision to lease or buy.

Once the account manager has adequately assessed the clients needs, the account manager locates at least one purchase or lease opportunity that best matches the client request. To locate opportunities, the account manager first accesses the Internet to research information including available options, safety features, benefits, pricing and incentives. If the account manager locates an automobile that closely matches the client's needs, the account manager accesses the customer relationship management system to search a database of preselected franchise automobile dealers for a franchise automobile dealer offering the particular automobile for sale or lease. Preferably, the franchise automobile dealers included within the database are selected based on a demonstrated history of reliable and honest salesmanship.

After an appropriate dealer has been selected, the account manager contacts the dealer to discuss the client's needs, current incentives, availability and tentative closing arrangements pending client approval.

Once the account manager has comprehensively researched lease or purchase opportunities for an opportunity that most closely matches the client's needs, the concierge contacts the client to discuss the opportunity. If the client is interested in test driving the automobile prior to making a purchase or lease decision, the account manager will contact the automobile dealer to arrange a client test drive prior to further actions.

In the event the client wishes to proceed with the purchase or lease transaction, the account manager discusses payment requirements, paperwork, closing and margin share arrangements with the client. Preferably, the account manager attempts to up-sell additional concierge services to the client at this time.

To close the lease or purchase transaction, the account manager attends closing with the client with an automobile dealer representative of a location that complies with state laws. In addition to overseeing the completion of the necessary paperwork, the account manager secures full payment of the service from the client and dealer. Preferably, the account manager discusses future concierge services with the client shortly after closing.

Upon return to the concierge office, the account manager accesses the future service scheduling aspect of the online customer relationship management system and schedules any future concierge services that the client desires. The account manager also accesses a client information aspect of the customer relationship management system to add or update the client's record. Client records comprise information including but not limited to the client's name, address and contact information, payment information, historical service information, vehicle information and account status including a prepaid status if applicable.

Preferably, the scheduling aspect of the online concierge service management system automatically prompts a concierge to contact the client (via mail, telephone e-mail, etc.) regarding any previously-scheduled future concierge services.

Additional automobile concierge services that may be offered in accord with the present invention include, but are not limited to, used automobile purchasing and disposition, financing, short term leases, accessory retrofitting, general vehicle information (resale rates, safety and reliability information, recall notices, etc.) and automotive errands (i.e., vehicle registration, inspection, insurance, emergency roadside service, etc.).

Another aspect of the present invention comprises an online system for implementing the concierge services described in detail, supra. FIG. 3 illustrates an overview of a preferred system 38 comprising at least one computer server 40 hosting an online customer relationship management application (CRM) 42, the computer server operably connected to a data warehouse 44 and operably serving a plurality of concierge client computers 46a-46n. Notably, the online customer relationship management application 42 may comprise a server-based application, a client-based application, or a combination of both.

In accord with the preferred system, account managers 48a-48n operating their respective concierge client computers 46a-46n receive service calls from clients 50a-50n. Service calls received from clients include but are not limited to requests for automobile repair, maintenance, vehicle purchase or lease, as discussed in detail, supra. In response to the service calls, the account managers communicate and coordinate with a plurality of third-party service providers (i.e., repair/maintenance centers, franchised automobile dealers, etc.) 54a-54n to arrange and carry out the clients' service requests.

In an alternate embodiment, account managers 48a-48n communicate with clients 50a-50n, and third-party service providers 54a-54n electronically. Preferably, electronic communication between these parties occurs via the Internet including e-mail and the World Wide Web.

To support the provision of concierge services discussed, supra, the account managers 48a-48n utilize their respective client computers 46a-46n to operate the online customer relationship management application 42 for access to the data warehouse 44. The data warehouse 44 comprises a plurality of separate or interrelated databases. Table 1 contains a nonexclusive listing of databases and corresponding content included within the data warehouse 44.

TABLE 1

| Database/Data Table | Contents |
|---|---|
| Client Information | Demographic Information |
| | Vehicle Information |
| | Historical Service History |
| | Account Information |
| | Prepaid Status |
| Service and Scheduling | Pending Work Orders |
| Information | Pending Sale/Lease |
| | Transactions |
| | Closed Work Order Archive |
| | Closed Sale/Lease |
| | Transaction Archive |
| | Future Service Reminders |
| Concierge Services | Available Maintenance/ |
| Information | Repair Services |
| | Pricing Schedules |
| | Bundling Information |
| | Rebates |
| Authorized Service Providers | Location |
| | Contact Information |
| | Services Provided |
| Authorized Automobile | Location |
| Dealers | Contact Information |
| | Services Provided |

In accord with a preferred embodiment of the present invention, the concierge services described, supra, are provided as a client incentive for entering into a business relationship. For example, an employer may offer concierge services to a potential employee as a non-traditional employment benefit. In another example, the concierge service is offered as a tenant amenity to entice a potential commercial or residential tenant to reside within a particular development. In yet another example, the concierge service is offered as part of a parking facility term contract. Notably, the bundling of the concierge services described, supra, is not limited to the recruiting, housing or parking industries. The concierge services herein described may provide a client with an incentive for entering into an unlimited number of business relationships. As a concierge service which provides a single point of contact for anything automotive, it is preferred to be considered as a total (automotive) transportation solution.

While the best mode for carrying out the invention has been described in detail, those familiar with the art to which this invention relates will recognize various alternative designs and embodiments for practicing the invention as defined by the following claims.

1. A method for providing an automobile concierge service to a client as an incentive for the client to enter into a business relationship, the method comprising:
receiving a client's request for at least one automobile service;
coordinating with at least one automobile service provider to schedule the at least one automobile service;
transporting the vehicle to the at least one automobile service provider to perform the at least one scheduled automobile service; and
returning the vehicle to the client after the at least one automobile service is complete wherein the automobile concierge service is provided to the client as an incentive for the client to enter into a business relationship.

2. The method of claim 1 wherein the business relationship comprises an employment arrangement and the concierge service is offered to an employee as an employment benefit.

3. The method of claim 1 wherein the business relationship comprises a landlord-tenant arrangement and the automobile concierge service is offered to a tenant as a tenant amenity.

4. The method of claim 1 wherein the business relationship comprises a parking term agreement.

5. The method of claim 1 wherein the at least one automobile service provider is selected from a database of automobile service providers that have been preselected to participate in the provision of automobile services.

6. The method of claim 1 additionally comprising scheduling the client's automobile for future concierge services.

7. The method of claim 1 additionally comprising receiving a client's request to acquire an automobile; and
locating at least one automobile acquisition opportunity that best satisfies the client's request.

8. The method of claim 7 wherein the client's automobile acquisition request comprises an assessment of the client's automobile needs.

9. The method of claim 7 additionally comprising closing the at least one automobile acquisition opportunity for the client.

10. The method of claim 7 additionally comprising scheduling a test drive of an automobile for the client.

11. The method of claim 7 wherein franchised automobile dealers provide the at least one automobile acquisition opportunity.

12. A computer-based system for supporting the provision of an automobile concierge service to a client as an incentive for the client to enter into a business relationship, the system configured to:
(i) receive input containing a client's request for at least one automobile service;
(ii) present output containing at least one automobile service provider capable of providing the at least one automobile service; and
(iii) receive input scheduling the at least one automobile service wherein the automobile concierge service is provided to the client as an incentive for the client to enter into a business relationship.

13. The system of claim 12 additionally configured to receive input selecting at least one automobile service provider to provide the at least one automobile service from a database of preselected automobile service providers.

14. The system of claim 12 additionally configured to generate an alert indicating that scheduled automobile service is due.

15. The system of claim 12 wherein the system is implemented on the Internet.

16. The system of claim 12 wherein a vehicle owner requests and schedules the at least one automobile service electronically via a communication network.

17. The system of claim 12 wherein the client's request for automobile service comprises a request to acquire an automobile.

18. A method for providing an automobile concierge service to an employee as an employment benefit, the method comprising:
receiving an employee's request for at least one automobile service;
coordinating with at least one automobile service provider to schedule the at least one automobile service,
transporting the vehicle to the at least one automobile service provider to perform the at least one scheduled automobile service, and
returning the vehicle to the employee after the at least one automobile service is complete wherein the automobile concierge service is provided to the employee as an employment benefit.

19. A system for providing an automobile concierge service to a client as an incentive for the client to enter into a business relationship, the system comprising:
a means for receiving an employee's request for at least one automobile service; and
a means for coordinating the provision of the at least one automobile service with at least one automobile service provider wherein the automobile concierge service is provided as an incentive for the client to enter into a business relationship.

20. The system of claim 19 wherein the business relationship comprises an employment arrangement and the concierge service is provided to an employee as an employment benefit.
